(19) United States
(12) Patent Application Publication
(10) Pub. No.: US 2019/0216025 A1
(43) Pub. Date: Jul. 18, 2019

(54) ENHANCED PRODUCTION OF ARBUSCULAR MYCORRHIZAL FUNGI IN A PLANT ROOT CULTURE

(71) Applicant: LOCUS AGRICULTURE IP COMPANY, LLC, SOLON, OH (US)

(72) Inventors: SEAN FARMER, NORTH MIAMI BEACH, FL (US); KEN ALIBEK, SOLON, OH (US)

(21) Appl. No.: 16/245,708

(22) Filed: Jan. 11, 2019

Related U.S. Application Data
(60) Provisional application No. 62/617,420, filed on Jan. 15, 2018.

(51) Int. Cl. A01G 18/10; C05F 11/08; A01G 18/20; A01G 24/30

(52) U.S. Cl. CPC A01G 18/10; C05F 11/08; A01G 2031/006; A01G 24/30; A01G 18/20

(57) ABSTRACT

The subject invention relates to novel systems, materials and methods for aseptic production of fungi on a large scale. In particular, the subject invention provides systems, materials and methods for producing endomycorrhizal fungal propagules, including spores and hyphal mycelium, using a two-stratum system supplemented with plant hormones and other natural growth stimulators.

### CROSS REFERENCE TO A RELATED APPLICATION

This application claims the benefit of U.S. Provisional Application Ser. No. 62/617,420, filed Jan. 15, 2018, which is incorporated herein by reference in its entirety.

### BACKGROUND OF THE INVENTION

Endomycorrhizal fungi are important components of many plants ecosystems. These fungi infect the roots of about 90% of plant species and create a crucial symbiotic relationship. Major species of mycorrhiza include Glomus, Gigaspora, Scutellospora, Acaulospora, Entrophosphora and Sclerocystis.

Even in distressed soils, endomycorrhizal fungi can enhance tree survival and growth, as they are considered natural biofertilizers. This is because they provide the host plant with water, nutrients, and protection from pathogens, in exchange for photosynthetic products. Arbuscular mycorrhizal fungi (AMF), a type of endomycorrhizal fungi, constitute a group of root obligate biotrophs that partake in this symbiotic exchange. Known as “obligate symbionts,” AMF must associate with plant roots to survive. In return for sugars from a plant, the long, thread-like structures of the fungi, the hyphae, act as an extension of a plant's root system and increase the plant's access to immobile nutrients, including phosphorus, zinc and copper.

While plant root hairs extend 1-2 mm into the soil, the AMF's hyphae travel through a greater volume of soil and can extend up to 15 cm from the plant's roots. The relationship between mycorrhizae and plants often enhances plant growth and yield, but even when no growth enhancement occurs, the majority of phosphorous uptake can be attributed to mycorrhizae. Mycorrhizae have also been credited with increasing a plant's disease resistance, improving a plant's ability to grow under drought conditions, and improving soil structure. Thus, AMF are important biotic soil components which, when missing or impoverished, can lead to less efficiently functioning ecosystems.

Many conventional fertilization and biocontrol practices (including antifungal, antibacterial and nematocidal activities) rely on harsh, expensive chemical fertilizers and pesticides. Reestablishing natural levels of AMF richness can provide a sustainable alternative to conventional agricultural practices that is not only more cost-effective, but also more environmentally-friendly.

In agriculture, horticulture and ornamental plant production, inoculation of a plant's roots with endomycorrhizal fungi may lead to increased crop production with a dramatically decreased dependence on chemical fertilizers. Despite their potential for use in forestry, agriculture, and horticulture, however, AMF have not been widely used on a commercial scale because, among other things, their biotrophic nature creates difficulties for mass production.

Typically, AMF must bind to a root system in order to grow. While commercially produced inoculum is available, it comes at a substantial cost to farmers. The price of commercial inoculum reflects the costs of current production methods, including greenhouse or lab space, as well as the labor and time associated with isolating AMF from the original medium and/or mixing the propagules with a carrier substrate. These costs, as well as shipping and handling, are all passed on to the farmer. Furthermore, AMF grow slowly, and yields are usually far too low in comparison to the amount of inoculum needed for commercial and large-scale farming applications.

Currently, there are two types of system for producing AMF: soil-based and soilless. Soil-based systems, where the fungi are produced in soil, are relatively cost-effective and can produce up to a few thousand propagules per gram; however, as noted, these amounts are not sufficient for large-scale applications. Moreover, soil-based systems are vulnerable to pest infestation, and it can be difficult to manage nutrient and water levels within the soil.

On the other hand, soilless systems, such as hydroponic, aeroponic, and root organ cultures, have lower risk for pest infestation. Furthermore, isolation of propagules is simpler in these systems. However, these systems must account for the difficulties of growing host plants and root systems without soil, and thus can be costly to engineer.

Fungi, such as AMF and other endomycorrhizal fungi, have the potential to play highly beneficial roles in, for example, agriculture, forestry and soil reclamation; however, large-scale production of AMF with current technology is not only difficult, but in some cases, completely unfeasible. Because of this, the possibility of using AMF for large farming applications is extremely limited.

Thus, systems and methods are needed for producing endomycorrhizal fungi-based products on a commercial scale.

### SUMMARY OF THE INVENTION

The present invention is directed toward the mass cultivation of fungi-based products for commercial application. In preferred embodiments, materials and methods are provided for the efficient production and use of beneficial fungi, as well as for the production and use of substances, such as metabolites, derived from these fungi and the substrate in which they are produced.

Advantageously, the subject invention can be used as a “green” process for producing fungi on a large scale and at low cost, without releasing harmful chemicals into the environment. Furthermore, the subject invention is operationally-friendly, and allows for the manufacturing of fungi-based products in amounts sufficient to treat thousands, or even millions, of acres of, e.g., crops and/or forests.

In preferred embodiments, systems, materials and methods are provided for aseptic large scale cultivation of endomycorrhizal fungi-based products. Methods are also provided for using these endomycorrhizal fungi-based products. In specific embodiments, the endomycorrhizal fungi-based products comprise AMF mycelium and/or AMF spores, which can be useful, for example, for direct inoculation of agricultural, horticultural and ornamental plants over large areas.

In certain embodiments, the subject invention provides for continual, large-scale, aseptic production of arbuscular mycorrhizal fungi (AMF) using a root-based soilless culture system and biological enhancers.

In specific embodiments, the system is a root-based, two-stratum aeroponic system comprising an upper stratum and a lower stratum.

In one embodiment, the upper stratum of the system comprises a soilless medium for aeroponically germinating and growing a plant. Preferably, the roots of the plant can grow into the soilless medium and initial attachment of AMF to the roots of the host plant, as well as initial fungal growth, can then take place in the upper stratum.

In one embodiment, the soilless medium can comprise a mixture of alginate beads with other nutrient medium components, such as, e.g., water, nitrogen sources, carbon sources, vitamins and minerals.

In one embodiment, the alginate beads comprise AMF inoculum and nutrient components. The beads can be mixed with seeds of the desired host plant and added to the soilless medium concurrently, or the beads can be added at some point before or after the seeds are planted and/or have germinated.

In one embodiment, the soilless medium can further comprise compounds for enhancing root growth in the host plant. The compounds for enhanced root growth can include, for example, hydrophobic particles of vermiculite or perlite, sterile sphagnum peat moss, and/or ground dolomitic lime.

In one embodiment, the lower stratum comprises an aeroponic chamber for a well-branched root system to grow and serve as a solid “nutrient medium” for large scale production of AMF. The lower stratum can be divided from the upper stratum by a mesh with 50 to 100-micron pore size, through which roots and AMF hyphae can grow and through which AMF spores can migrate.

The aeroponic chamber of the lower stratum can comprise a nebulizer for atomizing liquid compositions throughout the chamber. Advantageously, the nebulizer can be used to provide, for example, enriched nutrient medium compositions and stimulator compositions to promote fungal growth and spore formation in a form that is accessible to the roots and AMF growing inside the aeroponic chamber.

In one embodiment, the system can utilize natural and/or artificial sources of light to enhance the growth and photosynthetic processes of the host plant. In one embodiment, to imitate natural growing conditions, the upper stratum can be provided with a light source while the lower stratum can be prevented from receiving light.

In one embodiment, the system can be fitted with a water source, such as, for example, a sprinkler or mister. Accordingly, the system can also be fitted with a drain to collect condensation or other leftover liquid that is not absorbed by the plants or fungi.

In one embodiment, the system can be operated manually. In another embodiment, the system can be controlled by a timer system for automated operation. The timer system can be used, for example, to control the application of water, nutrients, light, air and growth stimulators to the plant and AMF.

In one embodiment, the system can be housed in a tent or greenhouse. Preferably, the housing structure is sterile, or otherwise capable of preventing contaminants and/or pathogenic agents from infecting the system.

In some embodiments, the subject invention provides methods for cultivating endomycorrhizal fungi on a large scale using the two-stratum soilless system. The methods and system can also be used to produce inocula of the endomycorrhizal fungi, including spores and/or mycelia, for cultivating the fungi on a small to large scale. In specific embodiments, the endomycorrhizal fungi are AMF, such as, e.g., Glomus Glade AMF.

In specific embodiments, the subject methods comprise preparing alginate beads comprising an AMF inoculum and nutrient sources; preparing a soilless nutrient medium comprising a mixture of the alginate beads with additional nutrient medium components, such as, e.g., water, nitrogen sources, carbon sources, vitamins and minerals; adding the soilless nutrient medium to the upper stratum of the two-stratum system; adding plant seeds to the soilless medium; and allowing the plant seeds to germinate and grow roots.

In one embodiment, the roots grow downward through the soilless medium and into the aeroponic chamber of the lower stratum. In one embodiment, initial growth of the AMF inoculum, as well as initial attachment of AMF to the roots, occurs in the upper stratum. In one embodiment, the AMF inoculum (alginate beads) can be mixed with seeds of the desired host plant and added to the soilless medium concurrently, or the beads can be added at some point before or after the seeds are planted and/or have germinated.

The host plant can be any plant capable of growing aeroponically, such as, for example, a species of grass (e.g. Sudan grass or Bahia grass).

In some embodiments, the method further comprises adding compounds for enhancing root growth in the host plant, as well as enhancing growth of the AMF attached thereto, to the soilless nutrient medium. The compounds for enhanced root growth can include, for example, hydrophobic particles of vermiculite or perlite, sterile sphagnum peat moss, and/or ground dolomitic lime.

In one embodiment, the method further comprises applying, to the roots, compositions for enhancing root and AMF growth, after the roots have grown into the aeroponic chamber of the lower stratum and have been inoculated with the AMF. Preferably, this is performed using an ultrasonic nebulizer, which can atomize liquid compositions throughout the chamber in a form accessible to the roots and fungi.

In one embodiment, the method comprises applying enriched nutrient medium and/or one or more natural or biological stimulator compositions to the roots using the nebulizer.

In one embodiment, the method further comprises harvesting the AMF.

In certain embodiments, the subject invention provides natural or naturally-derived stimulator compositions for enhancing the attachment of AMF to plant roots and for increasing the yield of fungal propagules, including both spores and hyphal mycelia. The natural stimulators can include, for example, indole-3-acetic acid (“IAA” or “auxin”), carotenoids or carotenoid derivatives (e.g., strigolactones), isoflavonoids (e.g., formononetin (biochanin A)) in the form of red clover and/or alfalfa sprout extracts, and/or combinations thereof.

Auxin serves as a signal for root growth and helps increase the efficiency of the establishment of the AMF symbiotic relationship. Preferably, IAA is in a naturally produced form, for example, produced by cultivation of various Bacillus spp. bacteria.

In one embodiment, the composition further comprises carotenoids or strigolactones (carotenoid derivatives). The carotenoids can be isolated from either fruits or vegetables, such as carrots, or from the supernatant of bacterial and/or yeast culture.

In one embodiment, the composition further comprises formononetin (biochanin A) to enhance AMF colonization and extraradical hyphal growth, and increase fungal sporulation. Biochanin A can be incorporated in the form of red clover and/or alfalfa sprout extracts.

### DETAILED DESCRIPTION OF THE INVENTION

The present invention is directed toward the mass cultivation of fungi-based products for commercial application. In preferred embodiments, materials and methods are provided for the efficient production and use of beneficial fungi, as well as for the production and use of substances, such as metabolites, derived from these fungi and the substrate in which they are produced.

Advantageously, the subject invention can be used as a “green” process for producing fungi on a large scale and at low cost, without releasing harmful chemicals into the environment. Furthermore, the subject invention is operationally-friendly, and allows for the manufacturing of fungi-based products in amounts sufficient to treat thousands, or even millions, of acres of, e.g., crops and/or forests.

In preferred embodiments, systems, materials and methods are provided for aseptic, large scale cultivation of endomycorrhizal fungi-based products. Methods are also provided for using these endomycorrhizal fungi-based products. In specific embodiments, the endomycorrhizal fungi-based products comprise AMF mycelium and/or AMF spores, which can be useful, for example, for direct inoculation of agricultural, horticultural and ornamental plants over large areas.

### Selected Definitions

As used herein, reference to a “fungi-based composition” means a composition that comprises components that were produced as the result of the growth of fungal cultures. Thus, the fungi-based composition may comprise the fungi themselves and/or by-products of fungal growth. The fungi may be in a vegetative state, in spore form, in mycelial form, in any other form of propagule, or a mixture of these. The fungi may be planktonic or in a biofilm form, or a mixture of both. The by-products of growth may be, for example, metabolites, cell membrane components, expressed proteins, and/or other cellular components. The fungi may be intact or lysed. In some embodiments, the fungi are present, with medium in which they were grown, in the fungi-based composition. The fungi may be present at, for example, a concentration of 1×10⁴, 1×10⁵, 1×10⁶, 1×10⁷, 1×10⁸, 1×10⁹, 1×10¹⁰, or 1×10¹¹, 1×10¹² or 1×10¹³ or more CFU per ml of composition.

The subject invention further provides “fungi-based products,” which are products that are to be applied in practice to achieve a desired result. The fungi-based product can be simply the fungi-based composition harvested from the fungal cultivation process. Alternatively, the fungi-based product may comprise further ingredients that have been added. These additional ingredients can include, for example, stabilizers, buffers, appropriate carriers, such as water, salt solutions, or any other appropriate carrier, added nutrients to support further fungal growth, non-nutrient growth enhancers, such as plant hormones, and/or agents that facilitate tracking of the fungi and/or the composition in the environment to which it is applied. The fungi-based product may also comprise mixtures of fungi-based compositions. The fungi-based product may also comprise one or more components of a fungi-based composition that have been processed in some way such as, but not limited to, filtering, centrifugation, lysing, drying, purification and the like.

As used herein, “enhancing” means improving or increasing. For example, enhanced plant health means improving the plant's ability grow and thrive, including the plant's ability to ward off pests and/or diseases, and the plant's ability to survive droughts and/or overwatering. Enhanced plant growth means increasing the size and/or mass of a plant, or improving the ability of the plant to reach a desired size and/or mass. Enhanced yields mean improving the end products produced by the plants, for example, by increasing the number of fruits per plant, increasing the size of the fruits, and/or improving the quality of the fruits (e.g., taste, texture).

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. A purified or isolated strain means that the strain is removed from the environment in which it exists in nature. Thus, the isolated strain may exist as, for example, a biologically pure culture, or as spores (or other forms of the strain) in association with an agricultural carrier.

In certain embodiments, purified compounds are at least 60% by weight (dry weight) the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. A metabolite can be an organic compound that is a starting material (e.g., glucose), an intermediate (e.g., acetyl-CoA) in, or an end product (e.g., n-butanol) of metabolism. Examples of metabolites include, but are not limited to, enzymes, acids, solvents, alcohols, proteins, vitamins, minerals, microelements, amino acids, polymers, and surfactants.

The terms “natural” and “naturally-derived,” as used in the context of a compound or substance is a material that is found in nature, meaning that it is produced from earth processes or by a living organism. A natural product can be isolated or purified from its natural source of origin and utilized in, or incorporated into, a variety of applications, including foods, beverages, cosmetics, and supplements. A natural product can also be produced in a lab by chemical synthesis, provided no artificial components or ingredients (i.e., synthetic ingredients that cannot be found naturally as a product of the earth or a living organism) are added.

By “reduces” is meant a negative alteration of at least 1%, 5%, 10%, 25%, 50%, 75%, or 100%.

By “reference” is meant a standard or control condition.

By “surfactant” is meant compounds that lower the surface tension (or interfacial tension) between two liquids or between a liquid and a solid. Surfactants act as detergents, wetting agents, emulsifiers, foaming agents, and dispersants. A “biosurfactant” is a surface-active substance produced by a living cell.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19, or 20 as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention.

Unless specifically stated or obvious from context, as used herein, the term “or” is understood to be inclusive. Unless specifically stated or obvious from context, as used herein, the terms “a,” “an,” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

Any compositions or methods provided herein can be combined with one or more of any of the other compositions and methods provided herein.

Other features and advantages of the invention will be apparent from the following description of the preferred embodiments thereof, and from the claims. All references cited herein are hereby incorporated by reference.

### Two-Stratum System Design and Operation

In preferred embodiments, systems are provided for aseptic large scale cultivation of endomycorrhizal fungi-based products, wherein the system is a root-based, two-stratum aeroponic system comprising an upper stratum and a lower stratum.

In an aeroponic system, a plant's rootzone is suspended inside an environment where the roots are exposed to an atomized nutrient solution. The top of the plant, or “canopy,” extends into the upper stratum while the roots extend into the lower stratum. The roots and the canopy of the plant are separated by a plant support structure.

In one embodiment, the subject system comprises a support structure or growing tray for supporting plants as they grow. Preferably, the support structure is a sturdy plastic or metal material. The support structure can comprise one or more containers, which can be filled with soilless growing medium and planted with seeds. Alternatively, the support structure itself can have soilless growing medium and seeds added to it. The bottom of the support structure should have openings large enough that the plant roots can grow through them.

In one embodiment, the lower stratum can be divided from the upper stratum by a support structure and/or mesh with 50-micron to 100-micron pore size, through which roots and AMF hyphae can grow and through which AMF spores can migrate.

The soilless medium for aeroponically germinating and growing a host plant for the AMF can comprise a mixture of alginate beads with other nutrient medium components, such as, e.g., water, carbon sources, nitrogen sources, vitamins and minerals.

To prepare the alginate beads, 3% aseptic sodium alginate solution containing nutrient components and AMF inoculum is continuously added into a sterile 5% solution of calcium chloride.

In one embodiment, the alginate beads containing AMF inoculum can be mixed with seeds of the desired host plant and added to the soilless medium. Alternatively, the AMF inoculum can be added at some point before or after the seeds are planted and/or have germinated.

Preferably, the roots of the plant grow into the soilless medium and initial AMF growth, as well as initial attachment of the fungus to the roots of the host plant, takes place in the upper stratum.

In one embodiment, the soilless medium can further comprise compounds for enhancing root growth in the host plant, as well as enhancing growth of the AMF attached thereto. The compounds for enhanced root growth can include, for example, hydrophobic particles of vermiculite or perlite, sterile sphagnum peat moss, and/or ground dolomitic lime. In one embodiment, the lower stratum comprises an aeroponic chamber for a well-branched root system to grow and serve as a solid “nutrient medium” for AMF growth. The aeroponic chamber of the lower stratum can comprise a nebulizer for atomizing liquid compositions for specified durations throughout the chamber to promote fungal growth and spore formation. Advantageously, the nebulizer can be used to spray, fog or mist atomized nutrient solution, stimulator compositions and water having a droplet size small enough to be accessible to the roots and AMF growing inside the aeroponic chamber.

In one embodiment, the nebulizer can be attached to a pressurized pump for supplying the liquid nutrients from, for example, a holding tank, reservoir or other container. The pump can be connected to the holding tank, reservoir or container via tubing.

In one embodiment, the system can be fitted with a watering system, such as, for example, sprinklers or misters connected to a pump, which pumps water from a water source via tubing.

In one embodiment, the chamber can be equipped with a drain for collecting condensation and/or leftover liquids and recycling them into, for example, the holding tank, reservoir or container where water and/or nutrient medium is stored. The nebulizer, sprinklers or misters can then recycle the unused liquid into the aeroponic chamber.

The spray interval and duration of spray from the nebulizer and/or water system can be adjusted for the specific environmental requirements of the plants and fungi being grown. For example, each spray cycle can last from 1 to 10 seconds, with one spray occurring at an interval of, for example, up to every 120 minutes.

In one embodiment, the system can be housed in a tent or greenhouse. Preferably, the housing structure is sterile, or otherwise capable of preventing contaminants and/or pathogenic agents from infecting the system. For example, the system can be fitted with water and/or air purification systems.

In one embodiment, the system can utilize natural and/or artificial sources of light to enhance the growth and photosynthetic processes of the host plant. In one embodiment, to imitate natural growing conditions, the upper stratum can be provided with a light source while the lower stratum can be prevented from receiving light.

In one embodiment, the system can be supplemented with an air circulation system. Preferably, air is supplied by a pump fitted with an air filter to prevent contamination of the air.

In one embodiment, growth medium, water, air, and equipment used in system are sterilized. Equipment components can be sterilized, for example, using steam or autoclaving. In other embodiments, the growth medium may be pasteurized or contain agents for pH control.

In one embodiment, the system can be operated manually. In another embodiment, the system can be controlled by a computer system for automated operation. The computer system can comprise a timer system, for example, to control the timing and amount of water, nutrient, light, air and stimulator applied to the system.

In one embodiment, the system has functional controls/sensors or may be connected to functional controls/sensors to measure important factors in the growing process, such as medium pH, light, oxygen, pressure, temperature, and humidity.

The system can include temperature controls. The system can be insulated so the growing process can remain at appropriate temperatures in low temperature environments. Additionally, if the system is exposed to the sun during operation, reflective material can be added to the outside to avoid raising the system temperature too high. For extreme environments, the system can utilize refrigeration, or electric or fuel heaters to control temperature.

A thermometer can be included and the thermometer can be manual or automatic. An automatic thermometer can manage the heat and cooling sources appropriately to control the temperature throughout the growing process. The desired temperatures can be programmed on-site or pre-programmed before the system is delivered to the fermentation site. The temperature measurements can then be used to automatically control the heating and cooling systems that are discussed above.

In one embodiment, the computer system can be used for measuring and adjusting system parameters. The computer can be connected to a thermometer, for example. The system can further be adapted for remote monitoring of these parameters, for example with a tablet, smart phone, or other mobile computing device capable of sending and receiving data wirelessly.

In a further embodiment, the system may also be able to monitor the growth of fungi (e.g., measurement of cell number and growth phases). Alternatively, a daily sample may be taken from the system and subjected to enumeration by techniques known in the art.

The system can include a frame for supporting the apparatus components (including the tanks, flow loops, pumps, etc.). The system can include wheels for moving the apparatus, as well as handles for steering, pushing and pulling when maneuvering the apparatus.

The system can be designed to be portable (e.g., the system can be suitable for being transported on a pickup truck, a flatbed trailer, or a semi-trailer).

### Methods of Cultivation Using the Subject System

The subject invention provides methods for cultivation of endomycorrhizal fungi and production of fungi-based products using the two-stratum aeroponic system. The methods utilize, for example, plant hormones and other biological compounds for stimulating growth of fungi. The methods can also be used to produce inocula of endomycorrhizal fungi, including spores and/or mycelia, for cultivating fungi on a small to large scale. In specific embodiments, the endomycorrhizal fungi are AMF, such as, e.g., Glomus Glade AMF.

As used herein “fermentation” and “cultivation” refer to growth of cells under controlled conditions. The growth could be aerobic or anaerobic. In preferred embodiments, fermentation is performed aerobically.

In one embodiment, the subject invention provides materials and methods for the production of biomass (e.g., viable cellular material), extracellular metabolites (e.g. small molecules, polymers and excreted proteins), residual nutrients and/or intracellular components (e.g. enzymes and other proteins).

In some embodiments, the subject invention provides methods for cultivating endomycorrhizal fungi on a large scale. Preferably, the endomycorrhizal fungi are AMF.

The subject invention can be used to cultivate any species of endomycorrhizal fungi, including fungi from the phylum Glomeromycota and the genera Glomus, Gigaspora, Acaulospora, Sclerocystis, and Entrophospora. Examples of endomycorrhizal fungi and/or AMF include, but not are not limited to, Glomus aggregatum, Glomus brasilianum, Glomus clarum, Glomus deserticola, Glomus etunicatum, Glomus fasciculatum, Glomus intraradices (Rhizophagus irregularis), Glomus lamellosum, Glomus macrocarpum, Gigaspora margarita, Glomus monosporum, Glomus mosseae (Funneliformis mosseae), Glomus versiforme, Scutellospora heterogama, and Sclerocystis sp.

In specific embodiments, the subject methods can comprise preparing alginate beads comprising an AMF inoculum and nutrient cources; preparing a soilless nutrient medium comprising a mixture of the alginate beads with additional nutrient medium components, such as, e.g., water, nitrogen sources, carbon sources, vitamins and minerals; adding the soilless nutrient medium to the upper stratum of the two-stratum system; adding plant seeds to the soilless medium; and allowing the plant seeds to germinate and grow roots.

In one embodiment, the roots grow downward through the soilless medium and into the aeroponic chamber of the lower stratum of the system. In one embodiment, initial growth of the AMF inoculum, as well as initial attachment of AMF to the roots, occurs in the upper stratum.

In one embodiment, the AMF inoculum (alginate beads) can be combined with the seeds prior to planting and then added to the soilless medium. Alternatively, the AMF inoculum can be added at some point before or after the seeds are planted and/or are germinated.

The host plant can be any plant capable of growing aeroponically, such as, for example, grasses (e.g. Sudan grass, Bahia grass, etc.), leafy greens (e.g., lettuce, kale, spinach, chard, collard greens), vine plants (e.g., tomatoes, cucumbers, eggplants), and herbs (e.g., chives, mint, basil, rosemary, thyme, oregano). Preferably, the plants are not root vegetables, such as potatoes, beets or carrots.

In some embodiments, the method further comprises adding compounds for enhancing root growth to the soilless nutrient medium, which can also serve to enhance growth of the AMF attached thereto. The compounds for enhanced root growth can include, for example, hydrophobic particles of vermiculite or perlite, sterile sphagnum peat moss, and/or ground dolomitic lime.

In one embodiment, the method further comprises applying compositions for enhancing root and AMF growth to the roots, after the roots have grown into the aeroponic chamber of the lower stratum and have been inoculated with the AMF. Preferably, this is performed using an ultrasonic nebulizer.

In one embodiment, the method comprises applying enriched nutrient medium to the roots using the nebulizer.

The components of the nutrient medium of both the upper and lower strata can comprise, e.g., water, nitrogen sources, carbon sources, vitamins and minerals, and lipid sources.

Lipid sources can include oils or fats of plant or animal origin, which contain free fatty acids or their salts or their esters, including triglycerides. Examples of fatty acids include, but are not limited to, free and esterified fatty acids containing from 16 to 18 carbon atoms, hydrophobic carbon sources, palm oil, animal fats, coconut oil, oleic acid, soybean oil, sunflower oil, canola oil, stearic and palmitic acid.

The culture media can further comprise carbon sources. The carbon source is typically a carbohydrate, such as glucose, xylose, sucrose, lactose, fructose, trehalose, galactose, mannose, mannitol, sorbose, ribose, and maltose; organic acids such as acetic acid, fumaric acid, citric acid, propionic acid, malic acid, malonic acid, and pyruvic acid; alcohols such as ethanol, propanol, butanol, pentanol, hexanol, erythritol, isobutanol, xylitol, and glycerol; fats and oils such as canola oil, soybean oil, rice bran oil, olive oil, corn oil, sesame oil, and linseed oil; etc. Other carbon sources can include arbutin, raffinose, gluconate, citrate, molasses, hydrolyzed starch, potato extract, corn syrup, and hydrolyzed cellulosic material. The above carbon sources may be used independently or in a combination of two or more.

In one embodiment, growth factors and trace nutrients for microorganisms are included in the nutrient media of the system. Inorganic nutrients, including trace elements such as iron, zinc, potassium, calcium copper, manganese, molybdenum and cobalt; phosphorous, such as from phosphates; and other growth stimulating components can be included in the culture medium of the subject systems. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic or mineral salts may also be included. Inorganic salts can be, for example, potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, calcium carbonate, sodium carbonate. These inorganic salts may be used independently or in a combination of two or more.

The culture medium of the subject system can further comprise sources of nitrogen. The nitrogen source can be, for example, in an inorganic form, such as potassium nitrate, ammonium nitrate, ammonium sulfate, ammonium phosphate, ammonia, urea, and ammonium chloride, or an organic form such as proteins, amino acids, yeast extracts, yeast autolysates, corn peptone, casein hydrolysate, and soybean protein. These nitrogen sources may be used independently or in a combination of two or more.

Each of the various components should be present in concentrations effective to promote growth of the roots and AMF production. It will be apparent to one of skill in the art that nutrient concentration, moisture content, pH, and the like may be modulated to optimize growth for a particular plant and/or AMF.

In one embodiment, the method further comprises harvesting the AMF. This can be done, for example, by removing the entire root system where the AMF is growing, or by isolating the AMF from the roots.

In a specific embodiment, the method of cultivation comprises sterilizing the subject fermentation reactors prior to fermentation.

The culture medium components (e.g., the carbon source, water, lipid source, micronutrients, etc.) can also be sterilized. This can be achieved using temperature decontamination and/or hydrogen peroxide decontamination (potentially followed by neutralizing the hydrogen peroxide using an acid such as HCl, H₂SO₄, etc.).

In a specific embodiment, the water used in the culture medium is UV sterilized using an in-line UV water sterilizer and filtered using, for example, a 0.1-micron water filter. In another embodiment, all nutritional and other medium components can be autoclaved prior to fermentation.

To further prevent contamination, the culture medium of the system may comprise additional acids, antibiotics, and/or antimicrobials, added before, and/or during the cultivation process. The one or more antimicrobial substances can include, e.g., streptomycin, oxytetracycline, sophorolipids, and rhamnolipids.

The pH of the medium should be suitable for the fungus and plant of interest. Buffering salts, and pH regulators, such as carbonates and phosphates, may be used to stabilize pH near an optimum value. When metal ions are present in high concentrations, use of a chelating agent in the liquid medium may be necessary. In certain embodiments, the pH may be adjusted manually or automatically using bases, acids, and buffers; e.g., HCl, KOH, NaOH, H₂SO₄, and/or H₃PO₄).

Total growth times can range from several days to several months, depending upon the species of plant used as the host plant.

In one embodiment, the method comprises applying one or more natural/naturally-derived stimulator compositions to the roots and AMF growing thereon, using the nebulizer. In certain embodiments, the subject invention provides natural/naturally-derived stimulator compositions for enhancing the attachment of AMF to plant roots and for increasing the yield of fungal propagules, including both spores and hyphal mycelia. Preferably, the natural stimulators are selected from plant hormones, such as, for example, indole-3-acetic acid (“IAA” or “auxin”), carotenoids or carotenoid derivatives (e.g., strigolactones), isoflavonoids (e.g., formononetin (biochanin A)) in the form of red clover and/or alfalfa sprout extracts, and/or combinations thereof.

Auxin serves as a signal for root growth and helps increase the efficiency of the establishment of the AMF symbiotic relationship. Preferably, IAA is in a naturally produced form, for example, produced by cultivation of a Bacillus species in the presence of tryptophan.

In one embodiment, the biological stimulator composition further comprises carotenoids or strigolactones (carotenoid derivatives). The carotenoids can be isolated from either fruits or vegetables, such as carrots, or from the supernatant of bacterial and/or yeast culture.

Strigolactones are plant hormones that stimulate the branching and growth of symbiotic AMF, increasing the probability of contact and establishment of a symbiotic association between the plant and fungus. The most important interface for symbiotic mineral acquisition are fungal arbuscules, which are highly-branched hyphal structures inside root cortex cells. Strigolactones also inhibit plant shoot branching.

In one embodiment, the stimulator composition further comprises formononetin (biochanin A) to enhance AMF colonization and extraradical hyphal growth, and increase fungal sporulation. Biochanin A can be incorporated in the form of red clover and/or alfalfa sprout extracts in a range of 0.1 to 400 ppm.

Biochanin A can be found in red clover, soy, alfalfa sprouts, peanuts, chickpeas and other legumes. When isolated, it can enhance AMF colonization through increasing fungal sporulation. Additionally, biochanin A can enhance AMF formation and plant growth parameters, including extraradical hyphal growth and stomatal activity.

### Preparation of Fungi-Based Products

The fungi-based products of the subject invention include products comprising the fungi and/or fungal growth by-products and optionally, the growth medium, host plant roots and/or additional ingredients such as, for example, water, carriers, adjuvants, nutrients, viscosity modifiers, and other active agents.

One fungi-based product of the subject invention is simply the root host containing the fungi and/or the fungal propagules and/or any residual nutrients. The product of fermentation may be used directly without extraction or purification. If desired, extraction and purification can be easily achieved using standard extraction methods or techniques known to those skilled in the art.

The fungi in the fungi-based products may be in an active or inactive form and/or in the form of vegetative cells, spores, mycelia, conidia and/or any form propagule. Preferably, the fungi are in the form of spores, mycelia or hyphae.

The fungi-based products may be used without further stabilization, preservation, and storage. Advantageously, direct usage of these fungi-based products preserves a high viability of the organisms, reduces the possibility of contamination from foreign agents and undesirable microorganisms, and maintains the activity of the by-products of fungal growth.

The fungi and/or medium resulting from the fungal growth can be removed from the growth chamber and transferred to a site for immediate use.

In other embodiments, the composition (fungi, medium, or fungi and medium) can be placed in containers of appropriate size, taking into consideration, for example, the intended use, the contemplated method of application, the size of the growth chamber, and any mode of transportation from growth facility to the location of use. Thus, the containers into which the fungi-based composition is placed may be, for example, from 1 gallon to 1,000 gallons or more. In other embodiments the containers are 2 gallons, 5 gallons, 25 gallons, or larger.

Upon harvesting the fungi-based composition from the growth chambers, further components can be added as the harvested product is placed into containers and/or transported for use). The additives can be, for example, buffers, carriers, other microbe-based compositions produced at the same or different facility, viscosity modifiers, preservatives, nutrients for microbe growth, nutrients for plant growth, tracking agents, pesticides, herbicides, animal feed, food products and other ingredients specific for an intended use.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

The fungi-based products of the subject invention may be, for example, microbial inoculants, biofertilizers, biopesticides, nutrient sources, remediation agents, health products, and/or biosurfactants.

In one embodiment, the cultivation products may be prepared as a spray-dried biomass product. The biomass may be separated by known methods, such as centrifugation, filtration, physical separation, decanting, or a combination thereof. The biomass product may be separated from the cultivation medium, spray-dried and/or freeze-dried.

In one embodiment, the cultivation products may be rich in at least one or more of fats, fatty acids, lipids such as phospholipid, vitamins, essential amino acids, peptides, proteins, carbohydrates, sterols, enzymes, and trace minerals such as, iron, copper, zinc, manganese, cobalt, iodine, selenium, molybdenum, nickel, fluorine, vanadium, tin and silicon. The peptides may contain at least one essential amino acid.

In specific embodiments, the fungi-based products of the subject invention provide science-based solutions that improve agricultural productivity by, for example, promoting crop vitality; enhancing crop yields; enhancing plant immune responses; enhancing insect, pest and disease resistance; controlling insects, nematodes, diseases and weeds; improving plant nutrition; improving the nutritional content of agricultural and forestry and pasture soils; and promoting improved and more efficient water use.

In one embodiment, the subject invention provides a method of improving plant health and/or increasing crop yield by applying the fungi-based products disclosed herein to soil, seed, or plant parts. In another embodiment, the subject invention provides a method of increasing crop or plant yield comprising multiple applications of the composition described herein.

Advantageously, the method can effectively control pests, and the corresponding diseases caused by pests, while a yield increase is achieved and side effects and additional costs are avoided.

In one embodiment, the subject invention further provides a composition comprising at least one type of fungi and/or a growth by-product produced by said fungus. The fungi in the composition may be in an active or inactive form and/or in the form of vegetative cells, spores, mycelia, conidia and/or any form of microbial propagule. The composition may or may not comprise the roots on which the fungi were grown. The composition may also be in a dried form or a liquid form.

In one embodiment, the composition is suitable for agriculture. For example, the composition can be used to treat soil, plants, and seeds. The composition may also be used as a pesticide.

In one embodiment, the subject invention further provides customizations to the materials and methods according to the local needs. For example, the method for cultivation of microorganisms may be used to grow those fungi located in the local soil or at a specific oil well or site of pollution. In specific embodiments, local soils may be used as the solid substrates in the cultivation method for providing a native growth environment. Advantageously, these fungi can be beneficial and more adaptable to local needs.

The cultivation method according to the subject invention not only substantially increases the yield of fungal products per unit of nutrient medium but also improves the simplicity of the production operation. Furthermore, the cultivation process can eliminate or reduce the need to concentrate fungi after finalizing fermentation.

Advantageously, the method does not require complicated equipment or high energy consumption, and thus reduces the capital and labor costs of producing fungi and their metabolites on a large scale.

### Methods of Producing Bacterial Auxins

In one embodiment, the subject invention provides methods of producing a bacterial metabolite by cultivating a microbe strain under conditions appropriate for growth and production of the metabolite; and purifying the metabolite. In preferred embodiments, the metabolite is an auxin.

In specific embodiments, the method comprises cultivating a strain of Bacillus bacteria for the production of natural IAA. IAA can be obtained from the supernatant resulting from fermentation of certain Bacillus spp., particularly in the presence of IAA precursor substances.

Plant hormones, such as auxins (e.g., IAA—indole-3-acetic acid, or IBA—indole-3-butiric acid) are likely emitted during the establishment of an arbuscular mycorrhizal (AM) symbiosis. Auxins might be an important factor for the development of lateral roots, which are the preferred infection sites for AMF.

It is already known that production of the IAA is also widespread among bacteria that inhabit the rhizosphere of plants. In particular, multiple Bacillus species are known to produce IAA, e.g., Bacillus subtilis, Bacillus amyloliguefaciens, Bacillus pumilis, Bacillus lichenoformis, Bacillus megaterium, and Bacillus uniflagellatus. Several different IAA biosynthesis pathways are used by these bacteria, with a single bacterial strain sometimes containing more than one pathway.

The growth vessel used according to the subject method can be any fermenter or cultivation reactor for industrial use. In a preferred embodiment, the reactor is part of a portable, distributed system for fermentation, which can be operated at or near the site of application.

In one embodiment, the vessel may optionally have functional controls/sensors or may be connected to functional controls/sensors to measure important factors in the cultivation process, such as pH, oxygen, pressure, temperature, agitator shaft power, humidity, viscosity and/or microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of microbes in a sample. The technique can also provide an index by which different environments or treatments can be compared.

In a preferred embodiment, the method includes supplementing the cultivation with a precursor to the desired metabolite to be produced. In a specific embodiment tryptophan is added to the culture medium. Tryptophan acts as a precursor for bacterial IAA production. In a specific embodiment, 5 mM tryptophan is added to the culture medium.

In one embodiment, the method includes supplementing the cultivation with a nitrogen source. The nitrogen source can be, for example, an organic or inorganic nitrogen source, such as, for example, a protein, an amino acid, potassium nitrate, yeast extract, yeast autolysates, urea, ammonia, or preferably ammonium salts, such as, ammonium nitrate ammonium sulfate, ammonium phosphate, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. The oxygenated air may be ambient air supplemented daily through mechanisms including impellers for mechanical agitation of the liquid, and air spargers for supplying bubbles of gas to the liquid for dissolution of oxygen into the liquid.

The method can further comprise supplementing the cultivation with a carbon source. The carbon source is typically a carbohydrate, such as glucose, sucrose, lactose, fructose, trehalose, mannose, raffinose, mannitol, sorbose, ribose, citrate, molasses, hydrolyzed starch, corn syrup, and/or maltose; organic acids such as acetic acid, fumaric acid, citric acid, propionic acid, malic acid, malonic acid, and/or pyruvic acid; alcohols such as ethanol, propanol, butanol, xylitol, pentanol, hexanol, isobutanol, and/or glycerol; fats and oils such as soybean oil, coconut oil, canola oil, rice bran oil, olive oil, corn oil, sesame oil, and/or linseed oil; etc. These carbon sources may be used independently or in a combination of two or more. In preferred embodiments, the carbon sources are selected from glucose, mannose, galactose, sucrose, and hydrolyzed starch.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in corn steep liquor, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate (e.g., ferrous sulfate heptahydrate), iron chloride, manganese sulfate, manganese sulfate monohydrate, manganese chloride, zinc sulfate, lead chloride, copper sulfate, calcium chloride, calcium carbonate, and/or sodium carbonate. These inorganic salts may be used independently or in a combination of two or more.

In some embodiments, the method for cultivation may optionally comprise adding additional acids and/or antimicrobials in to the substrate before and/or during the cultivation process. Antibacterial substances can include antibiotics, such as, for example, streptomycin, oxytetracycline. Other antibacterial substances can include one or more of sophorolipids, rhamnolipids and hops, among others known in the fermentation arts.

The pH of the mixture should be suitable for the microorganism of interest, though advantageously, stabilization of pH using buffers or pH regulators is not necessary when using the subject cultivation methods. Control or maintenance of pH in the course of the fermentation may be accomplished using manual or automatic techniques conventional in the art, such as using automatic pH controllers for adding base. Preferred bases employed for pH control include but are not limited to NaOH and KOH. In preferred embodiments, the optimum pH for cultivation ranges between about 3.0 to 6.0.

In one embodiment, the method for cultivation is carried out at about 5 to about 100° C., preferably, 15 to 40° C., more preferably, 25 to 30° C. In a further embodiment, the cultivation may be carried out continuously at a constant temperature. In another embodiment, the cultivation may be subject to changing temperatures.

The method and equipment for cultivation of microorganisms and production of the microbial by-products can be performed in a batch process or a quasi-continuous process.

In one embodiment, total sterilization of equipment and substrate used in the subject cultivation methods is not necessary. However, the equipment and substrate can optionally be sterilized. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control bacterial growth.

In one embodiment, the fermentation reactors are not sterilized using traditional methods. Instead, a method of empty vessel sanitation can be used, which comprises treating the internal surfaces of the reactor vessel with 2 to 3% hydrogen peroxide and rinsing with bleach and high pressure hot water.

In one embodiment, the subject invention further provides a method for producing microbial metabolites such as hormones, biopolymers, ethanol, lactic acid, beta-glucan, proteins, peptides, metabolic intermediates, polyunsaturated fatty acid, and lipids. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the substrate. In another embodiment, the method for producing microbial growth by-product may further comprise steps of concentrating and purifying the microbial growth by-product of interest. In a further embodiment, the substrate may contain compounds that stabilize the activity of microbial growth by-product.

In one embodiment, all of the microbial cultivation composition is removed upon the completion of the cultivation (e.g., upon, for example, achieving a desired spore density, or density of a specified metabolite). In this batch procedure, an entirely new batch is initiated upon harvesting of the first batch.

In another embodiment, only a portion of the fermentation product is removed at any one time. In this embodiment, biomass with viable cells remains in the vessel as an inoculant for a new cultivation batch. The composition that is removed can be a cell-free substrate or contain cells. In this manner, a quasi-continuous system is created.

### Local Production of Fungi-Based Products

In certain embodiments of the subject invention, a microbe growth facility comprising one or more systems of the subject invention produces fresh, high-density microorganisms and/or microbial growth by-products of interest on a desired scale. The microbe growth facility may be located at or near the site of application. The facility produces high-density microbe-based compositions in batch, quasi-continuous, or continuous cultivation.

The microbe growth facilities of the subject invention can be located at the location where the microbe-based product will be used (e.g., a farm). For example, the microbe growth facility may be less than 300, 250, 200, 150, 100, 75, 50, 25, 15, 10, 5, 3, or 1 mile from the location of use.

Because the microbe-based product can be generated locally, without resort to the microorganism stabilization, preservation, storage and transportation processes of conventional microbial production, a much higher density of microorganisms can be generated, thereby requiring a smaller volume of the microbe-based product for use in the on-site application or which allows much higher density microbial applications where necessary to achieve the desired efficacy. This makes the system efficient and can eliminate the need to stabilize cells or separate them from their culture medium. Local generation of the microbe-based product also facilitates the inclusion of the growth medium in the product. The medium can contain agents produced during the fermentation that are particularly well-suited for local use.

Locally-produced high density, robust cultures of microbes are more effective in the field than those that have remained in the supply chain for some time. The microbe-based products of the subject invention are particularly advantageous compared to traditional products wherein cells have been separated from metabolites and nutrients present in the fermentation growth media. Reduced transportation times allow for the production and delivery of fresh batches of microbes and/or their metabolites at the time and volume as required by local demand.

The microbe growth facilities of the subject invention produce fresh, microbe-based compositions, comprising the microbes themselves, microbial metabolites, and/or other components of the medium in which the microbes are grown. If desired, the compositions can have a high density of vegetative cells or propagules, or a mixture of vegetative cells and propagules.

In one embodiment, the microbe growth facility is located on, or near, a site where the microbe-based products will be used, for example, within 300 miles, 200 miles, or even within 100 miles. Advantageously, this allows for the compositions to be tailored for use at a specified location. The formula and potency of microbe-based compositions can be customized for a specific application and in accordance with the local conditions at the time of application.

Advantageously, distributed microbe growth facilities provide a solution to the current problem of relying on far-flung industrial-sized producers whose product quality suffers due to upstream processing delays, supply chain bottlenecks, improper storage, and other contingencies that inhibit the timely delivery and application of, for example, a viable, high cell-count product and the associated medium and metabolites in which the cells are originally grown.

Furthermore, by producing a composition locally, the formulation and potency can be adjusted in real time to a specific location and the conditions present at the time of application. This provides advantages over compositions that are pre-made in a central location and have, for example, set ratios and formulations that may not be optimal for a given location.

The microbe growth facilities provide manufacturing versatility by their ability to tailor the microbe-based products to improve synergies with destination geographies. Advantageously, in preferred embodiments, the systems of the subject invention harness the power of naturally-occurring local microorganisms and their metabolic by-products.

Local production and delivery within, for example, 24 hours of fermentation results in pure, high cell density compositions and substantially lower shipping costs. Given the prospects for rapid advancement in the development of more effective and powerful microbial inoculants, consumers will benefit greatly from this ability to rapidly deliver microbe-based products.

We claim:

1. A system for large scale, aseptic production of arbuscular mycorrhizal fungi (AMF), the system comprising:
an upper stratum, into which the canopy of a plant can grow;
a lower stratum comprising an aeroponic chamber, into which the plant's rootzone can grow; and
a support structure, which separates the upper stratum from the lower stratum and serves to support the plant during growth,
wherein an inoculum of AMF is mixed with a soilless nutrient medium and placed in the support structure, and wherein a plant seed is planted in the soilless nutrient medium and allowed to germinate and grow into the upper and lower strata.

2. The system of claim 1, wherein the upper and lower strata are further separated by a 50-micron to 100-micron mesh.

3. The system of claim 1, wherein the AMF inoculum comprises sodium alginate beads, an inoculum of one or more species of AMF, and optionally, added nutrients.

4. The system of claim 1, wherein the soilless nutrient medium comprises sources of carbon, nitrogen, vitamins, minerals and lipids.

5. The system of claim 4, wherein the soilless nutrient medium further comprises hydrophobic particles of vermiculite or perlite, sterile sphagnum peat moss, and/or ground dolomitic lime.

6. The system of claim 1, wherein the AMF initially grow and attach to plant roots in the upper stratum before growing into the lower stratum.

7. The system of claim 1, wherein the ultrasonic nebulizer is used to atomize liquid compositions into the aeroponic chamber and onto the roots and AMF growing therein.

8. The system of claim 7, wherein the atomized liquid compositions can comprise one or more of water, nutrients, and natural stimulator compounds.

9. The system of claim 8, wherein the natural stimulator compounds are bacterial-produced auxin (IAA), carotenoids or strigolactones (carotenoid derivatives), formononetin (biochanin A), or a combination thereof.

10. The system of claim 9, wherein biochanin A is added in a concentration of 0.1 to 400 ppm in the form of red clover extract and/or alfalfa sprout extract.

11. The system of claim 1, comprising a natural or artificial light source.

12. The system of claim 1, comprising a drain for collecting water and leftover nutrients from the aeroponic chamber.

13. The system of claim 1, wherein the system is connected to a water source.

14. The system of claim 1, wherein the system is controlled by an automatic timer, which controls the timing and amount of light, water, nutrients, air and stimulators that are applied to the plants and fungi.

15. A method for cultivating an arbuscular mycorrhizal fungi (AMF), the method comprising:
preparing alginate beads comprising an inoculum of one or more species of AMF and nutrients;
preparing a soilless nutrient medium comprising a mixture of the alginate beads with nutrients selected from water, nitrogen sources, carbon sources, vitamins and minerals, and lipids;
adding the soilless nutrient medium to the support structure of a system of claims 1 through 14;
adding plant seeds to the soilless medium; and
allowing the plant seeds to germinate and grow into a plant having a canopy and roots.

16. The method of claim 15, wherein the plant seeds are of a plant capable of growing aeroponically, said plant selected from grasses, leafy greens, vine plants and herbs.

17. The method of claim 15, further comprising adding to the soilless nutrient medium, compounds for enhancing root and AMF growth.

18. The method of claim 17, wherein the compounds for enhancing root and AMF growth are hydrophobic particles of vermiculite or perlite, sterile sphagnum peat moss, ground dolomitic lime and/or combinations thereof.

19. The method of clam 15, wherein the roots grow into the aeroponic chamber after being inoculated with AMF, and wherein a composition for stimulating AMF and root growth is applied to the roots using the ultrasonic nebulizer.

20. The method of claim 19, wherein the composition for stimulating AMF and root growth comprises enriched nutrient medium and one or more natural stimulators.

21. The method of claim 20, wherein the one or more natural stimulators are bacterial-produced auxin (IAA), carotenoids or strigolactones (carotenoid derivatives), formononetin (biochanin A), or a combination thereof.

22. The system of claim 21, wherein biochanin A is added in a concentration of 0.1 to 400 ppm in the form of red clover extract and/or alfalfa sprout extract.

23. The method of claim 15, wherein the AMF are from the Glomus clade.
